(19) United States
(12) Patent Application Publication
(10) Pub. No.: US 2021/0395470 A1
(43) Pub. Date: Dec. 23, 2021

(54) Thermoplastic Vulcanizate Compositions Comprising Encapsulated Stannous Chloride

(71) Applicant: ExxonMobil Chemical Patents Inc., Baytown, TX (US)

(72) Inventors: Prashant Bhadane, Houston, TX (US); Ranjan Tripathy, Sugar Land, TX (US); Oscar O. Chung, Houston, TX (US); Christopher E. Hrbacek, Pensacola, FL (US); Raymond Vaughn, Akron, OH (US); Kathy B. Cabrera, Dayton, TX (US)

(21) Appl. No.: 17/292,147

(22) PCT Filed: Nov. 6, 2019
(86) PCT No.: PCT/US2019/059966

§ 371 Date: May 7, 2021

Related U.S. Application Data
(60) Provisional application No. 62/767,173, filed on Nov. 14, 2018.

(51) Int. Cl. C08J 3/22; C08J 3/12; C08J 3/24; C08K 3/16; C08K 9/10; C08K 3/34; C08K 5/01

(52) U.S. Cl. CPC C08J 3/223; C08J 3/226; C08J 3/12; C08J 3/24; C08K 3/16; C08K 2201/005; C08K 3/346; C08K 5/01; C08J 2323/12; C08J 2323/16; C08K 9/10

(57) ABSTRACT

Masterbatch compositions comprising encapsulated stannous chloride for use in the production of thermoplastic vulcanizates, and methods related thereto. For example, the present disclosure provides for a composition comprising stannous chloride powder encapsulated in a carrier compound, the carrier compound being solid at a temperature in the range of 15.5° C. to 260° C. (60° F. to 500° F.).

### PRIORITY

This application claims priority to Provisional Application No. 62/767,173, filed Nov. 14, 2018, the disclosure of which is incorporated herein by reference.

### FIELD

This present disclosure relates a masterbatch comprising encapsulated stannous chloride for use in the production of thermoplastic vulcanizates, and methods related thereto.

### BACKGROUND

Thermoplastic elastomers (or TPE) are materials that are both elastomeric and thermoplastic, yet are distinguished from thermoset rubbers, which are elastomeric but not thermoplastic due to the cross-linking or vulcanization of the rubber, and are distinguished from general thermoplastics which are generally stiff and hard, but not elastomeric.

Thermoplastic vulcanizate (TPV) is a class of TPE where cross-linked rubber forms a dispersed, particulate, elastomeric phase within a stiff thermoplastic phase, such that TPE properties are achieved. TPV compositions are conventionally produced by dynamic vulcanization. Dynamic vulcanization is a process whereby a rubber component is cross-linked, or vulcanized, under intensive shear and mixing conditions within a blend of at least one non-vulcanizing thermoplastic polymer component while at or above the melting point of the thermoplastic polymer component. Typically, the rubber component forms cross-linked, elastomeric particles dispersed uniformly throughout the thermoplastic. Dynamically vulcanized thermoplastic elastomers consequently have a combination of both thermoplastic and elastic properties and conventional plastic processing equipment can extrude, inject, or otherwise mold, and thus press and shape TPV compositions, into useful products alone or in composite structures with other materials. That is, TPV compositions possess the elasticity of conventional elastomers and the processability of thermoplastics, which makes TPVs attractive for a large number of applications, such as in oil and gas, automotive, industrial, and consumer market segments.

Various additives may be added to a TPV composition to impart certain desirable properties thereto, such as cure acceleration, tensile strength, wear resistance, heat resistance, and the like. One such additive is stannous chloride, also known as tin (II) chloride (SnCl₂), which may be incorporated into a TPV composition as a curing accelerator and/or initiator (i.e., to accelerate and/or initiate the curing of a curing agent, such as a phenolic resin). However, stannous chloride is a known hazardous material that may compromise industrial hygiene in manufacturing settings. Neat stannous chloride is known as corrosive and an irritant, and has been implicated in maladies related to inhalation toxicity, skin sensitization, germ cell mutagenicity, reproductive toxicity, and aquatic toxicity. Accordingly, stannous chloride, typically in powder form, is very difficult to handle during TPV manufacturing, which must be metered into small and accurately controlled quantities, which impose serious challenges for commercial material conveying and feed metering processes, for example. Additionally, pure anhydrous stannous chloride is particularly hydroscopic, and its melting point can drop from about 247° C. to about 37° C. as it absorbs water and forms a dihydrate. At room temperature, pure anhydrous stannous chloride is in powder form and, accordingly, provides a large surface area for water absorption and aggregate formation, which further complicates its conveyance and metering.

It is known from, for example, British Patent No. 2455981B, that stannous chloride may be encapsulated by extrusion in an insoluble thermoplastic polymer, such as polypropylene, polyethylene, or poly(meth)acrylic acid. The resultant encapsulate is reported to provide a safe and readily transportable and easily storable form of stannous chloride, which can be used for a variety of industrial uses, including the cross-linking of a polymer mixture comprising natural rubber.

Similarly, International Patent Publication No. WO2015/008053A1 discloses stannous chloride entrained in a thermoplastic polymer, wherein the stannous chloride is a particulate form of stannous chloride comprising a stannous chloride particle core coated with a layer comprising stannous oxide. The composition is reported as being useful in the preparation of natural and synthetic rubbers, particularly when used in a coextrusion process.

In addition, U.S. Publication No. 2013/0041090A1 discloses a method for producing a thermoplastic elastomer composition, the method involving subjecting an ethylene-α-olefin-based copolymer rubber (A) and a polyolefin-based resin (B) in the presence of an alkylphenol resin (C) and a metal halide (D) to dynamic thermal treatment within a melt-kneading apparatus, wherein the metal halide (D) is a powder, and a mixture of a powder of the metal halide (D) and a particle having a volume-average particle diameter of 0.1 μm to 3 mm is continuously fed to the melt-kneading apparatus.

Despite these proposals, to date there appears to have been no disclosure or suggestion of a masterbatch of stannous chloride powder that are encapsulated in low molecular compounds that remain solid at processing and storage temperatures for use in the production of TPVs, and which increase the handling and processability of pure stannous chloride without compromising the physical characteristics of the TPVs.

### SUMMARY OF THE EMBODIMENTS

This present disclosure relates a masterbatch comprising encapsulated stannous chloride for use in the production of thermoplastic vulcanizates, and methods related thereto.

In one or more aspects, the present disclosure provides a composition comprising stannous chloride powder encapsulated in a carrier compound. The carrier compound is solid at a temperature in the range of 15.5° C. to 260° C. (60° F. to 500° F.) and selected from the group consisting of an oligomer, a natural wax, an oleocheinical, a water-soluble polymer, a non-thermoplastic polymer, and any combination thereof.

In one or more aspects, the present disclosure provides a method for producing a composition comprising stannous chloride powder encapsulated in a carrier compound, the carrier compound being solid at a temperature in the range of 15.5° C. to 260° C. (60° F. to 500° F.) and selected from the group consisting of an oligomer, a natural wax, an oleochernical, a water-soluble polymer, a non-thermoplastic polymer, and any combination thereof. The method includes supplying stannous chloride powder and the carrier compound to a mixer; compounding the stannous chloride powder and the carrier compound in the mixer at a temperature above a inciting point of the carrier compound to form a molten mixture; and cooling the molten mixture to form the composition.

In one or more aspects, the present disclosure provides method for producing a thermoplastic vulcanizate (TPV) including supplying components comprising a rubber component, a thermoplastic component, a curing agent, and the composition to a mixer. The composition comprising stannous chloride powder encapsulated in a carrier compound, the carrier compound being solid at a temperature in the range of 15.5° C. to 260° C. (60° F. to 500° F.) and selected from the group consisting of an oligomer, a natural wax, an oleochemical, a water-soluble polymer, a non-thermoplastic polymer, and any combination thereof. The components are mixed at a temperature above a melting point of the thermoplastic component to melt the thermoplastic component and at least partially, cross-link the rubber component to produce a heterogeneous product comprising particles of die rubber component dispersed in a matrix of the thermoplastic component.

### DETAILED DESCRIPTION

This present disclosure relates a masterbatch comprising encapsulated stannous chloride for use in the production of thermoplastic vulcanizates, and methods related thereto.

Described herein are masterbatches of stannous chloride powder encapsulated in a carrier compound, methods of producing such masterbatches, and uses of the resultant masterbatches in the production of thermoplastic vulcanizates (TPV). Stannous chloride is typically added to TPV compositions in relatively small amounts as a Lewis acid, curing accelerator and/or curing initiator. However, pure stannous chloride presents a number of hazards during handling and manufacturing of the TPV. The encapsulated compositions of the present disclosure have various advantages including health risk reductions, such as minimizing the potential for skin burns, eye damage, respiratory irritation, reproductive mutagenicity, and the like, and any combination thereof. Additionally, more accurate metering may be realized using the masterbatches described herein compared to individually feeding pure stannous chloride powder components to a final thermoplastic vulcanizate composition, enhanced storage and transportability compared to pure stannous chloride, and the like, and combinations thereof. Further, the dynamic vulcanization process benefits from a low to non-dusting feedstock that improves the accuracy of dosing by minimization of dust flyaway loss, and possible reduction of housekeeping and dust collection costs.

One or more illustrative embodiments incorporating the embodiments of the present disclosure are included and presented herein. Not all features of a physical implementation are necessarily described or shown in this application for the sake of clarity. It is understood that in the development of a physical embodiment incorporating the embodiments of the present disclosure, numerous implementation-specific decisions must be made to achieve the developer's goals, such as compliance with system-related, business-related, government-related, and other constraints, which vary by implementation and from time to time. While a developer's efforts might be time-consuming, such efforts would be, nevertheless, a routine undertaking for those of ordinary skill in the art and having benefit of this disclosure.

Unless otherwise indicated, all numbers expressing quantities of ingredients, properties such as physical properties, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

When numerical lower limits and numerical upper limits are listed herein, ranges from any lower limit to any upper limit are contemplated, whether or not explicitly listed.

While compositions and methods are described herein in terms of “comprising” various components or steps, the compositions and methods can also “consist essentially of” or “consist of” the various components and steps.

All priority documents, patents, publications, and patent applications, test procedures (such as ASTM methods), and other documents cited herein are fully incorporated by reference to the extent such disclosure is not inconsistent with this disclosure and for all jurisdictions in which such incorporation is permitted.

Various terms as used herein are defined below. To the extent a term used in a claim is not defined below, it should be given the broadest definition persons in the pertinent art have given that term as reflected in one or more printed publications or issued patents.

As used herein, the term “masterbatch,” and grammatical variants thereof, refers to a concentrated mixture of additives, in this case at least stannous chloride powder, encapsulated during a heating process into a carrier compound, as described according to the embodiments of the present disclosure. The masterbatch may be cooled and pelletized or otherwise cut or crushed, for example, into smaller particulates.

As used herein, the term “encapsulated,” and grammatical variants thereof, refers to at least partial coating of the surface of a substance (e.g., stannous chloride powder, and agglomerates thereof). The term “encapsulated” does not require 100% coating, but encompasses 100% coating. Generally, the encapsulated stannous chloride (with the carrier compound), and resultant masterbatch composition (free flowing) particles (e.g., pellets, granules, flakes, pastilles, and the like) described in the embodiments herein is coated in an amount of greater than about 50%, up to 100%, encompassing any value and subset therebetween.

As used herein, the term “stannous chloride,” and grammatical variants thereof, refers to both di-hydrated (also referred to as dihydrous) and anhydrous SnCl₂ (tin (II) chloride) powder. In some embodiments, anhydrous stannous chloride is preferred for encapsulation and use in the TPV compositions of the present disclosure because the melting point of the anhydrous stannous chloride is relatively higher (i.e., about 247° C.). However, any one or both in combination of anhydrous and/or di-hydrated stannous chloride may be used in accordance with the embodiments of the present disclosure. Any manufactured or otherwise commercially available source of stannous chloride may be used in accordance with the embodiments of the present disclosure.

As used herein, the term “carrier compound,” and grammatical variants thereof, refers to a compound that is at least solid at a temperature in the range of 15.5° C. to 260° C. (60° F. to 500° F.) and capable of at least partially encapsulating stannous chloride. For example, in some instances, the carrier compound may be solid at a temperature in the range of 15.5° C. to 26.7° C. (e.g., room temperature), but may also be solid at temperatures outside of such range (e.g., at temperatures of 15.5° C. to 260° C.). The carrier compound may be any compound type meeting the aforementioned requirements and that is compatible with the components of and formation of a TPV (i.e., the TPV component chemistry and the dynamic vulcanization process, or the ability of the stannous chloride to function as a cure accelerator and/or initiator), does not adversely affect the physical properties of the resultant TPV, and does not cause phase separation of die stannous chloride encapsulated therein (e.g., due to differences in polarity or specific gravity).

In some instances, the carrier compound has a weight average molecular weight of less than 2000 grams/mole (g/mol) and is solid at a temperature in die range of 15.5° C. to 260° C. (60° F. to 500° F.), encompassing any value and subset therebetween. For example, in some embodiments the carrier compound is solid at a temperature in the range of 15.5° C. to 240° C. or 15.5° C. to 200° C., or 15.5° C. to 180° C., or 15.5° C. to 150° C., or 15.5° C. to 100° C., or 15.5° C. to 80° C., encompassing any value and subset therebetween. For example, the carrier compound is solid at a temperature up to its processing temperature (e.g., melting temperature) or, in some instances, at room temperature or transport and storage temperatures (e.g., about 15.5° C. to 26.7° C.). The carrier compound described herein has a weight average molecular weight of less than 2000 g/mol, such as in the range of less than 2000 g/mol to 100 g/mol, encompassing any value and subset therebetween, such as from 1500 g/mol to 100 g/mol, or 1000 g/mol to 100 g/mol, or 1000 g/m of to 400 g/mol, and the like.

In alternative or combination embodiments, the carrier compound may include, but is not limited to, au oligomer (as opposed to previously used polymer encapsulants, as described herein below), a natural wax (e.g., beeswax, Candelilla wax, Carnauba wax, rice bran wax, sunflower wax, berry wax, Myrica fruit wax, Laurel wax, and the like), an oleoehemical (e.g., saturated oils, esters, derivatives thereof and the like), and the like, and any combination thereof. These carrier compounds may be water soluble or water insoluble, in some embodiments.

Moreover, in some embodiments, water-soluble polymers (e.g., those having a molecular weight characteristic of polymers rather than oligomers) may be used as the carrier compound. Such water soluble polymers, while having a higher molecular weight (e.g., greater than about 2000 g/mol), remain solid at a temperature in the range of 15.5° C. to 260° C. An example of such a water-soluble polymer for use as the carrier compound may include, but is not limited to, polyvinyl alcohol. Other non-thermoplastic polymers may additionally be used, without departing from the scope of the present disclosure.

As stated above, insoluble thermoplastic polymer carriers for encapsulating stannous chloride have been previously disclosed. Polymers are defined by the International Union of Pure and Applied Chemistry (IUPAC) Gold Book as a “substance composed of macromolecules,” and macromolecules are defined by the IUPAC Gold Book as a “molecule of high relative molecular mass, the structure of which essentially comprises the multiple repetition of units derived, actually or conceptually, from molecules of low relative molecular mass.” (International Union of Pure and Applied Chemistry, Compendium of Chemical Terminology Gold Book, Version 2.13), These polymers have molecular weights ranging from a few thousand to as high as millions of gm/mol. The degree of polymerization (i.e., the number of monomeric units in a macromolecule or oligomer molecule) of a macromolecule polymer is in principle, unlimited and infinite and, in practice at least very high, including significantly greater than 100, for example.

Accordingly, the carrier compounds described in the present disclosure have molecular weights that are far reduced compared to polymers. In some instances, these carrier compounds are oligomers comprising oligomer molecules, defined by the IUPAC Gold Book as “molecule[s] of intermediate relative molecular mass, the structure of which is essentially comprise a small plurality of units derived, actually or conceptually, from relative molecular mass.” (International Union of Pure and Applied Chemistry, Compendium of Chemical Terminology, Gold Book, Version 2.3.3). These oligomers have, by definition, a relatively lower molecular mass (or molecular weight) as compared to polymers. While oligomers may range in molecular weight, the oligomers for use as the carrier compounds of the present disclosure have a weight average molecular weight of less than 900 g/mol, such as in the range of 100 g/mol to 900 g/mol, or in the range of 200 g/mol to 900 g/mol, encompassing any value and subset therebetween.

Moreover, the degree of polymerization of an oligomer is significantly less than that of a polymer and is more defined compared to the very large range (with theoretically no upper limit) of a polymer. The degree of polymerization of the oligomers for use in the embodiments of the present disclosure as a carrier compound are in a range of 2 to 100, encompassing any value and subset therebetween, such as less than 100, or less than 50, for example. This defined degree of polymerization in turn contributes to the oligomer's more defined physical properties, such as, for example, lower viscosity during the high temperature TPV compounding and associated ease of handling, as well as greater encapsulation efficiency (i.e., the ability to encapsulate greater surface area). That is, the use of an oligomer as the carrier compound in the embodiments described herein may be particularly advantageous because such oligomers may impart a reduced viscosity during TPV composition; this reduced viscosity eases handling and formation of a TPV composition. Moreover, use of an oligomer carrier compound can reduce costs because a lesser amount of oligomer carrier compound may be needed to encapsulate a larger quantity of stannous chloride, further allowing for more concentrated masterbatches of encapsulated stannous chloride.

The carrier compounds of the present disclosure are in a solid phase (i.e., is not flowing) at a temperature in the range of 15.5° C. to 260° C. (60° F. to 500° F.), encompassing any value and subset therebetween (e.g., having a melting temperature of ≥260° C. (≥500° F.)). Accordingly, at least during typical handling and storage of the encapsulated stannous chloride of the present disclosure, such as prior to use in the manufacture of a TPV composition, the carrier compound remains in a solid state form. This solid state form prevents phase separation of the stannous chloride from the carrier compound, thereby maintaining the health and safety and manufacturing advantages gained from the encapsulation. It is to be appreciated that compounds that are in solid phase at temperatures less than 15.5° C. or greater than 260° C. may additionally be used as carrier compounds, provided that they remain in a solid state said range, without departing from the scope of the present disclosure. For example, in some instances, the carrier compounds may be in a solid state in broader or narrower ranges. In certain embodiments, the carrier compounds of the present disclosure are in a solid state in the range of 15.5° C. to 240° C., or 15.5° C. to 200° C., or 15.5° C. to 180° C., or 15.5° C. to 150° C. or 15.5° C. to 100° C., or 15.5° C. to 80° C., encompassing any value and subset therebetween.

In some embodiments, the oligomer may be amorphous, glassy, low molecular weight (i.e., less than 900 g/mol) hydrocarbon oligomers. For example, such oligomers may be cycloaliphatic hydrocarbon resins, which may or may not be aromatic modified. These oligomers may have a molecular weight of less than 900 g/mol, such as in the range of 250 g/mol to 900 g/mol, or such as in the range of 500 g/mol to 900 g/mol, encompassing any value or subset therebetween. The degree of polymerization of these oligomers may be less than 100, or less than 50, or less than 25, or less than 20, or less than 15, or in the range of 2 to 10, or 2 to 50, or 2 to 25, or 2 to 20, or 2 to 15, encompassing any value and subset therebetween. Additionally, such oligomers are solid in the range of 15.5° C. to 260° C. Examples of such suitable commercially available oligomers may include, but are not limited to, ESCOREZ™ tackifying resins (ExxonMobil Chemical Company, Houston, Tex.), such as the ESCOREZ™ 5300 series, 5400 series, and 5600 series.

The term “thermoplastic vulcanizate,” and grammatical variants thereof, including “thermoplastic vulcanizate composition,” “thermoplastic vulcanizate material,” or “TPV,” and the like, is broadly defined as any material that includes a dispersed, at least partially vulcanized, rubber component and a thermoplastic component (e.g., a polyolefinic thermoplastic resin). A TPV material can further include other ingredients, other additives, or combinations thereof. Examples of commercially available TPV material include SANTOPRENE™ thermoplastic vulcanizates (ExxonMobil Chemical Company, Houston, Tex.).

The term “vulcanizate,” and grammatical variants thereof, means a composition that includes some component (e.g., rubber) that has been vulcanized. The term “vulcanized,” and grammatical variants thereof, is defined herein in its broadest sense, as reflected in any issued patent, printed publication, or dictionary, and refers in general to the state of a composition after all or a portion of the composition (e.g., a cross-linkable rubber) has been subjected to some degree or amount of vulcanization. Accordingly, the term encompasses both partial and total vulcanization. A preferred type of vulcanization is “dynamic vulcanization,” discussed below, which also produces a “vulcanizate.” Also, in at least one specific embodiment, the term “vulcanized” refers to more than insubstantial vulcanization (e.g., curing (or cross-linking)) that results in a measurable change in pertinent properties (e.g., a change in the melt flow index (MFI) of the composition by 10% or more, according to any ASTM-1238 procedure). In at least one or more contexts, the term vulcanization encompasses any form of curing (or cross-linking), both thermal and chemical, that can be utilized in dynamic vulcanization.

The term “dynamic vulcanization,” and grammatical variants thereof, means vulcanization or curing of a curable rubber component blended with a thermoplastic component under conditions of shear at temperatures sufficient to plasticize the mixture. In at least one embodiment, the rubber component is simultaneously cross-linked and dispersed as micro-sized particles within the thermoplastic component. Depending on the degree of cure, the rubber component to thermoplastic component ratio, compatibility of the rubber component and thermoplastic component, the kneader type and the intensity of mixing (shear rate), other morphologies, such as co-continuous rubber phases in the plastic matrix, are possible.

The terms “partially vulcanized” or “partially cross-linked,” and grammatical variants thereof (e.g., “at least partially vulcanized” or “at least partially cross-linked”), with reference to a rubber component is one wherein more than 5 weight percent (wt. %) of the rubber component (e.g., cross-linkable rubber component) is extractable in boiling xylene, subsequent to vulcanization, preferably dynamic vulcanization (e.g., cross-linking of the rubber phase of the thermoplastic vulcanizate). For example, at least 5 wt. % and less than 20 wt. % or 30 wt. % or 50 wt. % of the rubber component can be extractable from the specimen of the thermoplastic vulcanizate in boiling xylene, encompassing any value and subset therebetween. The percentage of extractable rubber component can be determined by the technique set forth in U.S. Pat. No. 4,311,628, which is hereby incorporated by reference in its entirety.

The rubber component of the thermoplastic vulcanizates described herein may be any material that is considered by persons skilled in the art to be a “rubber,” preferably a cross-linkable rubber component prior to vulcanization) or cross-linked rubber component (e.g., after vulcanization). For example, the rubber component may be any olefin-containing rubber including, but not limited to, ethylene-propylene copolymers (EPM), including particularly saturated compounds that can be vulcanized using free radical generators such as organic peroxides, as described in U.S. Pat. No. 5,177,147. Other rubber components may include, but are not limited to, ethylene propylene diene monomer (EPDM) rubber or EPDM-type rubber, for example, an EPDM-type rubber can be a terpolymer derived from the polymerization of at least two different monoolefin monomers having from 2 to 10 carbon atoms, preferably 2 to 4 carbon atoms, and at least one poly-unsaturated olefin having from 5 to 20 carbon atoms, encompassing any value and subset therebetween. Additional examples of suitable rubber components are described herein below.

The rubber component may also be a butyl rubber. The term “butyl rubber.” and grammatical variants thereof, includes a polymer that predominantly includes repeat units from isobutylene but also includes a few repeat units of a monomer that provides a site for cross-linking. Monomers providing sites for cross-linking may include, but are not limited to, a polyunsaturated monomer, such as a conjugated diene or divinylbenzene. In one or more embodiments, the butyl rubber polymer may be halogenated to further enhance reactivity in cross-linking, which are referred to herein as “halobutyl rubbers.”

Further, the rubber component may be homopolymers of conjugated dienes having from 4 to 8 carbon atoms and rubber copolymers having at least 50 weight percent repeat units from at least one conjugated diene having from 4 to 8 carbon atoms, encompassing any value and subset therebetween.

The rubber component may also be synthetic rubber, which can be nonpolar or polar depending on the comonomers. Examples of synthetic rubbers include, but are not limited to, synthetic polyisoprene, polybutadiene rubber, styrene-butadiene rubber, butadiene-acrylonitrile rubber, and the like. Amine-functionalized, carboxy-functionalized, or epoxy-functionalized synthetic rubbers can also be used; examples including, but not limited to, maleated EPDM.

Suitable preferred rubber components include, but are not limited to, an ethylene-propylene rubber; an ethylene-propylene-diene rubber; a natural rubber; a butyl rubber; a halobutyl rubber; a halogenated rubber copolymer of p-alkylstyrene and at least one isomonoolefin having 4 to 7 carbon atoms; a copolymer of isobutylene and divinyl-benzene; a rubber homopolymer of a conjugated diene having from 4 to 8 carbon atoms; a rubber copolymer having at least 50 weight percent repeat units from at least one conjugated diene having from 4 to 8 carbon atoms and a vinyl aromatic monomer having from 8 to 12 carbon atoms, or acrylonitrile monomer, or an alkyl substituted acrylonitrile monomer having from 3 to 8 carbon atoms, or an unsaturated carboxylic acid monomer, or an unsaturated anhydride of a dicarboxylic acid; or any combination thereof.

In one or more embodiments, the rubber component is present in the amount of from about 5 wt. % by weight to about 85 wt. % of the total weight of the combined rubber component and thermoplastic component of the present disclosure, encompassing any value and subset therebetween. In one or more embodiments, the rubber component is present in the amount of less than 70 wt. %, or less than 50 wt. % of total weight of rubber component and thermoplastic component.

As used herein, the “thermoplastic component,” and grammatical variants thereof; of the thermoplastic vulcanizates of the present disclosure refers to any material that is not a “rubber” and that is a polymer or polymer blend considered by persons skilled in the art as being thermoplastic in nature (e.g., a polymer that softens when exposed to heat and returns to its original condition when cooled to room temperature). The term “thermoplastic component” encompasses any type of curing, reversible or irreversible; and accordingly encompasses thermoset plastics, as used herein. The thermoplastic component may comprise one or more polyolefins, including polyolefin homopolymers and polyolefin copolymers. In one or more embodiments, the polyolefinic thermoplastic component comprises at least one of i) a polymer prepared from olefin monomers having 2 to 7 carbon atoms and/or ii) copolymer prepared from olefin monomers having 2 to 7 carbon atoms with a (meth)acrylate or a vinyl acetate. Illustrative polyolefins can be prepared from mono-olefin monomers including, but not limited to, ethylene, propylene, 1-butene, isobutylene, 1-pentene, 1-hexene, 1-octene, 3-methyl-1-pentene, 4-methyl-1-pentene, 5-methyl-1-hexene, mixtures thereof and copolymers thereof with (meth)acrylates and/or vinyl acetates. In one or more preferred embodiments, the polyolefin thermoplastic component comprises polyethylene, polypropylene, ethylene-propylene copolymer, and any combination thereof. Preferably, the thermoplastic component is not vulcanized or not cross-linked.

In one or more embodiments, the thermoplastic component contains polypropylene. As used herein, the term “polypropylene,” and grammatical variants thereof, broadly means any polymer that is considered a “polypropylene” by persons skilled in the art (as reflected in at least one patent or publication), and includes, but is not limited to, homo, impact, and random polymers of propylene. In one or more embodiments, the thermoplastic component is or includes isotactic polypropylene. Preferably, the thermoplastic component contains one or more crystalline propylene homopolymers or copolymers of propylene having a melting temperature greater than 10.5° C. as measured by differential scanning calorimetry (DSC). Preferred copolymers of propylene include, but are not limited to, terpolymers of propylene, impact copolymers of propylene, random polypropylene copolymers, and any combination thereof. Preferred comonomers have 2 carbon atoms, or from 4 to 12 carbon atoms. Preferably, the comonomer is ethylene. Such thermoplastic components and methods for making the same are described in U.S. Pat. No. 6,342,565, which is incorporated herein by reference in its entirety.

In one or more embodiments, the thermoplastic component is present in the amount of from about 15 wt. % to about 95 wt. % based upon the total weight of the combined rubber component and thermoplastic component, encompassing any value and subset therebetween. In one or more embodiments, the thermoplastic component is present in the amount of more than 30 wt. % or more than 50 wt. % based upon the total weight of rubber component and thermoplastic resin component. In one or more embodiments, the amount of the thermoplastic component in the TPV foam composition according to the present invention is at least greater than about 80 wt. %, or about 85 wt. %, or about 90 wt. %, or about 95 wt. %, based on the total weight of the composition, encompassing any value and subset therebetween.

As used herein and except as stated otherwise, the term “copolymer,” and grammatical variants thereof, refers to a polymer derived from two or more monomers (e.g., terpolymers, tetrapolymers, and the like).

The TPVs of the present disclosure comprising the masterbatch compositions of stannous chloride encapsulated in a carrier polymer are vulcanized (e.g., cured (or cross-linked)) using one or more curing agents. As used herein, the term “curing agent, and grammatical variants thereof, refers to a compound that is used to cause a cure of an elastomer or elastomeric composition. The term “curing agent” may be used interchangeably with the terms “cross-linking agent,” “curative,” and “vulcanizing agent.” The term “cure,” and grammatical variants thereof, as used herein, refers to both cross-linking reactions and the process(es) used to achieve cross-linking of polymer chains of the TPV (e.g., rubber component).

Examples of curing agents may include, but are not limited to, sulfur, metal oxides, metal carboxylates, organometallic compounds, radical inducers, phenolic compounds, and the like, and any combination thereof.

In some embodiments, the curing agent is at least a Group 2-14 metal oxide or metal ligand complex, wherein at least one ligand is able to undergo a substitution reaction with the inducer compound, in some embodiments, the at least one curing agent is a metal oxide which including, but not limited to, zinc oxide, magnesium oxide, calcium oxide, aluminum(I) oxide, chromium trioxide, iron(II) oxide, iron(III) oxide, nickel(II) oxide, hydrated lime, alkali carbonates, hydroxides, and any combination thereof, in certain embodiments, the metal-based curing agents selected for use in the elastomer compositions of the present disclosure may include zinc oxide. These metal oxides can be used in conjunction with the any other curing agent(s) described herein, such as in combination with a phenolic curing agent.

Alone or in conjunction with any one or more of the curing agents described herein, an additional suitable curing agent for use in the TPV compositions of the present disclosure includes a phenolic compound. Suitable examples of phenolic compounds that may be used as curing agents include, but are not limited to octyl phenyl resins, alkylphenol disulfides, melamine-based phenyl resins, and any combination thereof. In certain embodiments, the phenolic compound selected for use in the TPV compositions of the present disclosure is octylphenol formaldehyde resin and/or alkylphenol disulfide. In some instances, the phenolic compound may additionally impart antioxidant qualities to the TPV composition, which may beneficially protect one or more components of the thereof from degradation. For example, alkylphenol disulfide may act as both a curing agent and an antioxidant.

In some embodiments, the curing agent(s) is present in the TPV composition in an amount of from about 0.3% to about 7% by weight of the TPV composition, encompassing any value and subset therebetween, such as from about 0.3% to about 5%, or about 0.3% to about 4% by weight of the TPV composition, encompassing any value and subset therebetween.

In one or more embodiments, additives may be added into the thermoplastic vulcanizates. The team “additive,” and grammatical variants thereof, includes any component of the thermoplastic vulcanizates of the present disclosure except the rubber component, the thermoplastic component, and the encapsulated stannous chloride component. Examples of suitable additives include, but are not limited to, oils (e.g., processing oils, extender oils, and the like), curatives, curing accelerators, particulate fillers, thermoplastic modifiers (e.g., elastomers such as VISTAMAXX™ polymers (ExxonMobil Chemical. Houston, Tex.), lubricants, antioxidants, antiblocking agents, stabilizers, anti-degradants, anti-static agents, waxes, foaming agents, pigments, processing aids, adhesives, tackifiers, plasticizers, wax, discontinuous fibers (such as world cellulose fibers), and the like, and any combination thereof.

As provided above, the present disclosure provides masterbatches of stannous chloride powder encapsulated in a carrier compound, methods of producing such masterbatches, and uses of the resultant masterbatches in the production of thermoplastic vulcanizates (TPV).

More specifically, embodiments of the present disclosure include a masterbatch composition comprising stannous chloride powder encapsulated in a carrier compound, as described above, the carrier compound being solid at a temperature m the range of 15.5° C. to 260° C. (60° F. to 500° F.).

The amount of stannous chloride present in the masterbatch composition (i.e., the composition comprising stannous chloride powder encapsulated in carrier compound) may be varied to the amount required in the target dynamic vulcanization process. In some embodiments, the amount of stannous chloride present in the masterbatch composition described herein is in the range of from about 0.5% to about 99.5% by total weight of the masterbatch composition (i.e., the total composition of the masterbatch composition, including any additives), encompassing any value and subset therebetween, such as in the range of from about 5% to about 80%, or about 7.5% to about 80%, or about 10% to about 90%, or about 50% to about 75%, or about 40% to about 50% by total weight of the masterbatch composition.

The amount of carrier compound present in the masterbatch composition (i.e., the composition comprising stannous chloride powder encapsulated in carrier compound) may be varied to the amount required in the target dynamic vulcanization process, and depending on the amount of stannous chloride included, as well as any additional ingredients, such as fillers, that may be included. In some embodiments, the amount of carrier compound present in the masterbatch composition described herein is in the range of from about 0.5% to about 99.5% by total weight of the masterbatch composition, encompassing any value and subset therebetween, such as in the range of from about 10% to about 80%, or about 20% to about 60%, or about 30% to about 40%, or about 40% to about 50% by total weight of the masterbatch composition.

In some embodiments, the carrier compound may further comprise one or more additives (i.e., other than the carrier compound and the stannous chloride), such as those discussed with reference to the TPV composition. Selection of the additive(s) may be included to facilitate addition of those additives into the TPV manufacturing process and/or make a simpler masterbatch solution and/or impart certain desirable qualities to the carrier fluid and the resultant encapsulated stannous chloride composition, such as to dilute the carrier compound to enhance encapsulation, offer tensile strength to the carrier compound, and the like, and any combination thereof. Selection of such an additive should not cause phase separation of the stannous chloride encapsulated within the carrier compound (e.g., due to differences in polarity or specific gravity). For example, it was found that use of certain process oils and other viscous fluids as a carrier compound encapsulating stannous chloride resulted in forced phase separation between the stannous chloride and the carrier compound due to significant specific gravity differences. As such, it is of importance in the embodiments of the present disclosure that the carrier compound be solid (and not liquid) to prevent such phase separation. It should be noted, however, that certain fluid additives may be combined with solid carrier compounds, without departing from the scope of the present disclosure.

In some embodiments, an additive filler material is included in the masterbatch compositions of the present disclosure. Such fillers may improve, for example, the masterbatch composition's processability (e.g., by diluting the carrier compound), strength; toughness; resistance to tearing, abrasion and flex fatigue; durability; and the like; and any combination thereof. Illustrative filler materials include, but are not limited to, clay, carbon black, silica, titanium dioxide, calcium carbonate, and any combination thereof. In some embodiments, depending on the particular carrier fluid selected, the masterbatch composition may include a clay filler material.

When included, the amount of filler material present in the masterbatch composition may be varied to the amount required to impart the desired properties to the carrier compound and the masterbatch composition. In some embodiments, the amount of filler material present in the masterbatch composition described herein is in the range of from 0.5% to 85% by total weight of the masterbatch composition, encompassing any value and subset therebetween. Generally, the particle size of the filler material is in the range of about 0.001 micrometers (μm) to about 1000 μm, encompassing any value and subset therebetween. As used herein, the term “particle size,” and grammatical variants thereof, refers to a size of an object (regardless of its shape) that is able to pass through a square area, where each side of the square area is equivalent to an equal numerical length.

Typically, and as discussed in greater detail below, the masterbatch composition is in the form of free flowing particles having a particles size in the range of 100 micrometers (μm) to 10 millimeters (mm), encompassing any value and subset therebetween. In some embodiments, the particles may be in the form of a pellet, granule, flake, pastilles, and the like, and any combination thereof. As used herein, the term “pellet,” and grammatical variants thereof, refers to a spherical or substantially spherical mass of a substance (e.g., masterbatch composition). Pellets may be formed, for example, by a rotary drum agglomerator, disc pelletizer, pan pelletizer, underwater pelletizer, and the like. As used herein, the term “granule,” and grammatical variants thereof, refers to an irregular, polygonal mass of a substance (e.g., the masterbatch composition of the present disclosure). Granules may be formed by cutting or otherwise removing (e.g., breaking) a portion from a larger mass of a substance, using a roll compactor or press, and the like. As used herein, the term “flake,” and grammatical variants thereof, refers to a flat and thin mass of a substance (e.g., the masterbatch composition). As used herein, the term “pastille,” and grammatical variants thereof, refers to a disc-shaped (e.g., lozenge-shaped) mass of a substance (e.g., the masterbatch composition). Flakes and pastilles may be formed using one or more of the methods described with reference to pellets and granules, in some embodiments. As used herein, the term “particle” will be used to collectively refer to the individual components of a masterbatch, encompassing any shapes including pellet, granule, flake, pastille, and the like.

The masterbatch composition may be produced by supplying the desired quantities of the stannous chloride powder, carrier compound, and any additive (e.g., filler material) to a mixer (e.g., an internal melt mixer), such as a batch mixer (e.g., Banbury mixer, Brabender internal mixer) or, in some embodiments, a continuous mixer (e.g., a single or twin screw extruder). The ingredients are then compounded in the mixer at a temperature above the melting point of the carrier compound(s), but generally below about 260° C., such as in the range of from about 15.5° C. to about 260° C., or 60° C. to 21.0° C., encompassing any value and subset therebetween, for a period of time to form a molten homogeneous mixture, generally in the range of about 2 to 10 minutes, but may be longer depending on the selected ingredients of the masterbatch composition. The molten mixture can then be cooled and cut or crushed or otherwise manufactured into particles (e.g., pellets, granules, flakes, and/or pastilles) for ease of feeding into the TPV manufacturing process for formation of a TPV composition, as described herein below. In some embodiments, prior to cooling, the molten mixture is extruded through a die to facilitate formation of the particles. Cutting or otherwise manufacturing the cooled masterbatch composition (or cooled extruded masterbatch composition) may be performed under water (e.g., under the surface of a water bath), in some embodiments.

The masterbatch compositions described herein may be used to form a TPV composition, where such TPV compositions may be extruded for forming a variety of useful articles. For example, the TPV compositions may be extruded, compression molded, blow molded, injection molded, and/or otherwise laminated into various shaped articles, including industrial parts such as automotive parts, appliance housings, consumer products, packaging, and the like. Illustrative mixing equipment may include, but is not limited to, extruders with kneaders or mixing elements with one or more mixing tips or flights, extruders with one or more screws, and extruders of co- or counter-rotating type. Suitable mixing equipment may include, for example, BRABENDER™ mixers, BANBURY™ mixers, BUSS™ mixers and kneaders, and FARREL™ continuous mixers, One or more of those mixing equipment, including extruders, can be used in series, without departing from the scope of the present disclosure. Additional details for making a TPV are described in U.S. Pat. No. 4,594,390, which is hereby incorporated by reference in its entirety.

The masterbatch compositions of the present disclosure, in particle form, may be included in the TPV compositions described herein in an amount of from about 0.06% to about 6% by weight of the TPV composition, encompassing any value and subset therebetween, such as from about 0.1% to about 5%, or about 0.1% to about 4%, or about 0.2% to about 3% by weight of the TPV composition.

Any process for making TPVs may be employed for forming the TPV compositions comprising the masterbatch compositions of the present disclosure, and as described herein. For example, the individual materials and components, such as the one or more rubber component(s), thermoplastic component(s), the masterbatch composition(s), the curing agent(s), and any additional additives, can be mixed at a temperature above the melting temperature of the thermoplastic components) to form a melt and to at least partially cure (or cross-link) the rubber component to produce a heterogeneous product comprising particles of the at least partially cross-linked rubber component dispersed in a matrix comprising the thermoplastic component. Generally the melting point, and thus the mixing temperature, may be in the range of from about 15.5° C. to about 260° C., such as about 100° C. to about 240° C., or about 140° C. to about 210° C., encompassing any value and subset therebetween. In some embodiments, the curing agent is introduced to the mixture after the melt is formed.

It is found that the stannous chloride masterbatches are surprisingly effective at maintaining desirable physical properties of the TPV compositions, even at wide ranging concentrations of the stannous chloride within the masterbatch compositions.

The TPV composition comprising the encapsulated stannous chloride of the present disclosure may have hardness as determined by ISO 868 (15 seconds) in the range of about 20 Shore A to about 60 Shore D, encompassing any value and subset therebetween. Shore A and Shore D hardness can be converted in most instances, where 60 Shore D is approximately 100 Shore A, for example. Such conversion will be readily known to one of skill in the art. For example, in some embodiments, the TPV comprising the encapsulated stannous chloride of the present disclosure may have a Shore A hardness in the range of about 20 to about 100, or about 50 to about 100, or about 55 to about 85, encompassing any value and subset therebetween. In some embodiments, the TPV comprising the encapsulated stannous chloride of the present disclosure may have a Shore 1) hardness in the range of about 5 to about 60, or about 10 to about 60, or about 30 to about 60, encompassing any value and subset therebetween.

The thermoplastic vulcanizate comprising the encapsulated stannous chloride of the present disclosure may have a specific gravity as determined by ISO 1183 in the range of about 0.8 to about 1.4, encompassing any value and subset therebetween. For example, in some embodiments, the TPV comprising the encapsulated stannous chloride of the present disclosure has a specific gravity in the range of about 0.9 to about 1.1, encompassing ally value and subset therebetween.

The TPV composition comprising the encapsulated stannous chloride of the present disclosure may have a 100% Modulus as determined by ISO 37 in the range of about 0.5 to about 10 megapascals (MPa), encompassing any value and subset therebetween. For example, in some embodiments, the TPV comprising the encapsulated stannous chloride of the present disclosure has a 100% Modulus in the range of about 1 MPa to about 8 MPa, or about 1 MPa to about 6 MPa, or about 2 MPa to about 6 MPa, encompassing any value and subset therebetween.

The TPV composition comprising the encapsulated stannous chloride of the present disclosure may have a tensile strength at break as determined by ISO 37 in the range of about 1 to about 20 megapascals (MPa), encompassing any value and subset therebetween. For example, in some embodiments, the TPV comprising the encapsulated stannous chloride of the present disclosure has a tensile strength at break in the range of about 1 MPa to about 8 MPa, or about 3 MPa to about 8 MPa, encompassing any value and subset therebetween.

The TPV composition comprising the encapsulated stannous chloride of the present disclosure may have an ultimate elongation at break as determined by ISO 37 in the range of about 50% to about 1000%, encompassing any value and subset therebetween. For example, in some embodiments, the TPV comprising the encapsulated stannous chloride of the present disclosure has an ultimate elongation at break in the range of about 50% to about 500%, or about 100% to about 500%, or about 200% to about 450%, or about 250% to about 400%, encompassing any value and subset therebetween.

The TPV composition comprising the encapsulated stannous chloride of the present disclosure may have a compression set as determined by ASTM D-395 in the range of about 15% to about 80%, encompassing any value and subset therebetween. For example, in some embodiments, the TPV comprising the encapsulated stannous chloride of the present disclosure has a compression set in the range of about 15% to about 70%, or about 15% to about 60%, or about 15% to about 55%, 15% to about 50%, or about 20% to about 45%, or about 25% to about 45%, encompassing any value and subset therebetween.

To facilitate a better understanding of the embodiments of the present invention, the following example of preferred or representative embodiments are given. In no way should the following example be read to limit, or to define, the scope of the disclosure.

### EXAMPLE

For purposes of convenience, the various specific test procedures used in the example described herein below are identified in Table 1. It is to be understood that a person of ordinary skill in the art may use various other published or well-recognized test methods to determine a particular property of the foam compositions described herein, without departing from the scope of the present disclosure, although the specifically identified procedures are preferred. Each claim should be construed to cover the results of any of such procedures, even to the extent different procedures may yield different results or measurement values.

TABLE 1

| Property | Testing Method |
|---|---|
| Shore A Hardness (15 sec) | ISO 868 |
| Specific Gravity (SG) | ISO 1183 |
| 100% Modulus | ISO 37 |
| Tensile Strength at Break | ISO 37 |
| Ultimate Elongation | ISO 37 |
| Compression Set (22 hours, 70° C.) | ASTM D-395 |

Various masterbatch compositions comprising anhydrous stannous chloride and an experimental carrier compound in accordance with the embodiments of the present disclosure were prepared, and compared to a masterbatch composition comprising anhydrous stannous chloride and a carrier compound of the polymer, polypropylene (“PP”). The experimental carrier compounds were oligomers of ESCOREZ™ 5340 (“CC5340”) and ESCOREZ™ 5616 (“CC5616”) tackifying resins (ExxonMobil Chemical Company, Houston, Tex.). In some examples (MB3, MB4, MB6, and MB7), an amount of additive filler material of clay was included in the masterbatch composition (e.g., for demonstrating use of the filler material for carrier compound dilution and imparting strength). The concentrations of the control sample (CTRL) and the experimental samples (MB1-MB7) are provided in Table 2. The concentration of each component is provided in % by weight of the total masterbatch composition; the symbol “-” indicates that the particular component was excluded from the masterbatch composition.

TABLE 2

| Component | CTRL | MB1 | MB2 | MB3 | MB4 | MB5 | MB6 | MB7 |
|---|---|---|---|---|---|---|---|---|
| SnCl₂ | 45 | 45 | 45 | 45 | 45 | 72.5 | 45 | 10 |
| PP | 55 | — | — | — | — | — | — | — |
| CC5340 | — | 55 | — | 27.5 | — | 27.5 | 45 | 45 |
| CC5616 | — | — | 55 | — | 27.5 | — | — | — |
| Clay | — | — | — | 27.5 | 27.5 | — | 10 | 45 |
| Total | 100 | 100 | 100 | 100 | 100 | 100 | 100 | 100 |

Each of the masterbatch compositions in Table 2 were prepared comprising the listed components and in the listed concentration in a Brabender internal melt mixer at 160° C., using a 100 revolutions per minute (rpm) rotor speed for five (5) minutes (min). After mixing in the internal melt mixer, the compositions were allowed to cool and harden at room temperature (RT). Thereafter, the compositions were broken into smaller pieces for use in a TPV reactive melt blending process.

Various experimental and control TPV compositions were prepared using the final CTRL and MB1-MB7 masterbatch compositions of Table 2, in combination with the additional components provided in Table 3.

TABLE 3

| Component | Function | Description |
|---|---|---|
| VISTALON ™ 3666 | Mineral Oil | Ethylene Propylene Diene |
| (available from | Extended Rubber | Monomer (EPDM) Rubber |
| ExxonMobil Chemical | Component | |
| Co., Houston, TX) | | |
| Mineral Oil | Rubber extender | Distilled Heavy Paraffinic |
| | | Oil |
| Polypropylene (PP) | Thermoplastic | Polypropylene Copolymer |
| | Component | |
| Clay | Filler Material | Calcined Aluminum |
| | | Silicate |
| Phenol-Formaldehyde | Curing Agent | Heat Reactive Alkyl |
| Resin | | Phenol-Formaldehyde |
| | | Resin |

The concentrations of the TPV compositions of control samples (C1 and C2) and the experimental samples (E1-E8) are provided in Table 4, The concentration of each component is provided in % by weight of the total TPV composition; the symbol “-” indicates that the particular component was excluded from the masterbatch composition.

TABLE 4

| Component | C1 | E1 | C2 | E2 | E3 |
|---|---|---|---|---|---|
| EPDM | 50.4 | 50.4 | 46.0 | 46.0 | 50.4 |
| Oil | 17.7 | 17.7 | 15.3 | 15.3 | 15.6 |
| PP | 11.0 | 11.0 | 18.8 | 18.8 | 11.0 |
| Filler | 19.1 | 19.1 | 18.1 | 18.1 | 19.1 |
| Curing Agent | 0.9 | 0.9 | 1.0 | 1.0 | 3.0 |
| ZnO | 0.4 | 0.4 | 0.4 | 0.4 | 0.4 |
| CTRL | 0.5 | — | 0.4 | — | — |
| MB1 | — | 0.5 | — | 0.4 | — |
| MB2 | — | — | — | — | 0.5 |
| MB3 | — | — | — | — | — |
| MB4 | — | — | — | — | — |
| MB5 | — | — | — | — | — |
| MB6 | — | — | — | — | — |
| MB7 | — | — | — | — | — |
| Component | E4 | E5 | E6 | E7 | E8 |
| EPDM | 50.4 | 50.4 | 50.5 | 50.4 | 50.4 |
| Oil | 15.6 | 15.6 | 15.6 | 15.6 | 15.6 |
| PP | 11.0 | 11.0 | 11.1 | 11.0 | 11.0 |
| Filler | 19.1 | 19.1 | 19.1 | 19.1 | 17.4 |
| Curing Agent | 3.0 | 3.0 | 3.0 | 3.0 | 3.0 |
| ZnO | 0.4 | 0.4 | 0.4 | 0.4 | 0.4 |
| CTRL | — | — | — | — | — |
| MB1 | — | — | — | — | — |
| MB2 | — | — | — | — | — |
| MB3 | 0.3 | — | — | — | — |
| MB4 | — | 0.5 | — | — | — |
| MB5 | — | — | 0.3 | — | — |
| MB6 | — | — | — | 0.5 | — |
| MB7 | — | — | — | — | 2.2 |

Each of the TPV compositions in Table 4 were prepared comprising the listed components and in the listed concentration. The EPDM and PP were reactively melt mixed in a Brabender internal melt mixer at 190° C., using a 100 rpm rotor speed for eight (8) min. The remaining materials, except the curing agent, (i.e., the oil, filler, ZnO, and specific masterbatch compositions (Table 2)) were added to the mixer, and mixing was continued for 2 to 3 min (e.g., to ensure that the components were fed into the mixer without issue). Thereafter, the curing agent was slowly added to the mixer, and mixing was continued for an additional 4 to 5 min. The compositions were removed from the melt mixer and compression molded into 2 mm thick plaques for physical property testing after being allowed to cool at RT for at least one day.

Specimens were cut from each of the control and experimental TPV plaque compositions (C1 and C2 and E1-E8, respectively) for physical property testing according to the test methods provided in Table 1, The physical property results are shown in Table 5,

TABLE 5

| Test | C1 | E1 | C2 | E2 | E3 |
|---|---|---|---|---|---|
| Hardness (Shore A) | 66.8 | 65.6 | 83.1 | 82.6 | 62.5 |
| Specific Gravity | 0.985 | 0.983 | 0.981 | 0.975 | 0.977 |
| 100% Modulus (MPa) | 2.8 | 2.7 | 4.4 | 4.5 | 2.3 |
| Tensile Strength at | 5.7 | 5.4 | 7.1 | 8.0 | 5.3 |
| Break (MPa) | | | | | |
| Ultimate Elongation (%) | 316 | 314 | 314 | 360 | 350 |
| Compression Set (%) | 27.3 | 29.7 | 41.2 | 34.7 | 32.1 |
| Test | E4 | E5 | E6 | E7 | E8 |
| Hardness (Shore A) | 60.4 | 60.8 | 63.1 | 62.1 | 59.5 |
| Specific Gravity | 0.978 | 0.978 | 0.977 | 0.977 | 0.971 |
| 100% Modulus (MPa) | 2.2 | 2.2 | 2.4 | 2.5 | 2.1 |
| Tensile Strength at | 4.3 | 4.4 | 5.2 | 5.2 | 3.6 |
| Break (MPa) | | | | | |
| Ultimate Elongation (%) | 294 | 312 | 338 | 311 | 268 |
| Compression Set (%) | 32.6 | 36.6 | 33.7 | 29.4 | 33.1 |

Comparing C1 and C2, the control C2 demonstrates greater hardness, which may be attributable, without being bound by theory, to the increased concentration of thermoplastic component and decreased concentration of rubber component as compared to C1.

Comparing C1, E1, and E3, each having identical formulations except that C1 comprises the control masterbatch, E1 comprises experimental masterbatch composition MB1 comprising ESCOREZ™ 5340 (Table 2), and E3 comprises experimental masterbatch composition MB2 comprising ESCOREZ™ 5615 (Table 2). Each of C1, E1, and E3 demonstrate very similar physical properties.

Similarly, comparing C1 and E2, having identical formulations except that C1 comprises the control masterbatch and E1 comprises experimental masterbatch composition MB2 comprising ESCOREZ™ 5615 (Table 2), the pair demonstrates very similar physical properties.

E4-E8 make use of different concentrations of the various experimental masterbatch compositions MB3-MB7 (Table 2) alone or in combination with a clay filler material and each demonstrates very similar physical properties. Indeed, even E6 comprising the experimental masterbatch composition MB5, having a high concentration of stannous chloride (75% by weight of the masterbatch) exhibits very similar physical properties. Accordingly, the masterbatch compositions comprising the carrier compounds as described herein are able to encapsulate high concentrations (as well as low concentrations) of stannous chloride with no influence on the resultant TPV in which the masterbatch is used. That is, the carrier compound is effective at encapsulation without interfering with the functionality of the stannous chloride in forming the TPV.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments and examples illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A composition comprising stannous chloride powder encapsulated in a carrier compound, the carrier compound being solid at a temperature in the range of 15.5° C. to 260° C. (60° F. to 500° F.) and selected from the group consisting of an oligomer, a natural wax, an oleochemical, a water-soluble polymer, a non-thermoplastic polymer, and any combination thereof.

2. The composition of claim 1, wherein the carrier compound comprises the oligomer, the natural wax, the oleochemical, or a combination thereof.

3. The composition of claim 1, wherein the carrier compound has a molecular weight of less than 2000 g/mol.

4. The composition of claim 1, wherein the compound is solid at a temperature in the range of 15.5° C. to 27.7° C.

5. The composition of claim 1, wherein the carrier compound comprises the oligomer.

6. The composition of claim 5, wherein the oligomer has a degree of polymerization in the range of 2 to 100.

7. The composition of claim 5, wherein the oligomer is an amorphous, glassy, hydrocarbon oligomer.

8. The composition of claim 1, wherein the stannous chloride powder is present in an amount of 0.5% to 99.5% by total weight of the composition.

9. The composition of claim 1, wherein the stannous chloride powder is one or more of anhydrous stannous chloride powder and di-hydrated stannous chloride powder.

10. The composition of claim 1, further comprising an additive.

11. The composition of claim 10, wherein the additive is a filler material.

12. The composition of claim 11, wherein the filler material is present in an amount of 0.5% to 85% by total weight of the composition.

13. The composition of claim 1, wherein the composition is in the form of one or more of free flowing pellets, granules, flakes, and pastilles.

14. The composition of claim 13, wherein the one or more free flowing pellets, granules, flakes, and pastilles have a particle size of from 100 micrometers to 10 millimeters.

15. A method for producing the composition of claim 1 comprising:
supplying stannous chloride powder and the carrier compound to a mixer;
compounding the stannous chloride powder and the carrier compound in the mixer at a temperature above a melting point of the carrier compound to form a molten mixture; and
cooling the molten mixture to form the composition.

16. The method of claim 15, further comprising extruding the molten mixture through a die prior to cooling.

17. The method of claim 15, further comprising one or more of pelletizing, granulizing, flaking, and pastillizing the cooled molten mixture.

18. The method of claim 17, wherein the one or more pelletized, granulized, flaked, and pastillized cooled molten mixture have a particle size of from 100 micrometers to 10 millimeters.

19. The method of claim 15, further comprising supplying a filler material to the mixer with the stannous chloride powder and the carrier compound.

20. The method of claim 19, wherein the filler material is clay.

21. The method of claim 19, wherein the filler material is present in an amount of 0.5% to 85% by total weight of the composition

22. The method of claim 15, wherein the temperature is in the range of from 15.5° C. to 260° C.

23. A method for producing a thermoplastic vulcanizate (TPV) comprising the composition of claim 1, the method comprising:
supplying components comprising a rubber component, a thermoplastic component, a curing agent, and the composition to a mixer;
mixing the components at a temperature above a melting point of the thermoplastic component to melt the thermoplastic component and at least partially cross-link the rubber component to produce a heterogeneous product comprising particles of the rubber component dispersed in a matrix of the thermoplastic component.

24. The method of claim 23, wherein the curing agent is supplied to the mixer after the rubber component, the thermoplastic component, and the composition.

25. The method of claim 23, wherein the thermoplastic component is polypropylene.

26. The method of claim 23, wherein the rubber component is ethylene propylene diene terpolymer.

27. The method of claim 23, wherein the temperature is in the range of from 15.5° C. to 260° C.

28. The method of claim 23, wherein the TPV has a hardness of from 20 Shore A to 60 Shore D.

29. The method of claim 23, wherein the TPV has a specific gravity of from 0.8 to 1.4.

30. The method of claim 23, wherein the TPV has a 100% Modulus of from 0.5 megapascal to 10 megapascals.

31. The method of claim 23, wherein the TPV has a tensile strength at break of from 1 megapascal to 20 megapascals.

32. The method of claim 23, wherein the TPV has an elongation at break of from 50% to 1000%.

33. The method of claim 23, wherein the TPV has a compression set of from 15% to 80%.
